(19) United States
(12) Patent Application Publication
(10) Pub. No.: US 2016/0246009 A1
(43) Pub. Date: Aug. 25, 2016

(54) Photonic Chip Surface Grating Coupler (SGC)-Based Optical Splitter and Optical Combiner

(71) Applicant: Huawei Technologies Co., Ltd., Shenzhen (CN)

(72) Inventor: Jia Jiang, Kanata (CA)

(21) Appl. No.: 14/626,350

(22) Filed: Feb. 19, 2015

(51) Int. Cl. G02B 6/34; G02B 6/126; G02B 6/293; G02B 6/30; G02B 6/124

(52) U.S. Cl. CPC G02B 6/34; G02B 6/305; G02B 6/124; G02B 6/29344; G02B 6/126; G02B 2006/12157

(57) ABSTRACT

An optical device comprising an optical interface comprising an optical waveguide disposed on a surface of a substrate, wherein the optical waveguide comprises a wide middle portion that tapers to two opposite narrow ends along a first direction and a second direction of light propagation opposite to the first direction, a diffraction grating disposed at about the wide middle portion of the optical waveguide, and an optical fiber in optical communication with the optical waveguide and the diffraction grating, wherein the optical fiber is positioned at about perpendicular to the surface and directed towards the diffraction grating to cause an incoming light signal from the optical fiber to split into a first portion and a second portion through a diffraction at the diffraction grating, and wherein the diffraction causes the first portion to propagate along the first direction and the second portion to propagate along the second direction.

### TECHNICAL FIELD

The present invention relates to a system and method for optical communications, and, in particular, to a surface grating coupler (SGC)-based optical splitter and optical combiner.

### BACKGROUND

Optical fibers have been widely used for the propagation of optical signals, especially to provide high-speed data communication links. Optical links using fiber optics may have various advantages over electrical links, for example, comparatively large bandwidths, comparatively high noise immunity, comparatively reduced power dissipation, and comparatively minimal crosstalk. Optical signals carried by optical fibers may be processed by a wide variety of optical devices, optoelectronic devices, and/or integrated circuits, such as photonic integrated circuits (PICs) and/or planar lightwave circuits (PLCs).

Recently, PICs have gained interest in research and industry for use in optical systems since PICs may provide high functionality, stability, reliability, compactness, and/or level of integration. One of the basic building components of PICs may be photonic waveguides, for example, for interconnecting optical components and/or optical circuits and interfacing with external connections for inputs and/or outputs. PICs may be integrated on various material platforms, such as silica-on-silicon, silicon-on-insulator, and/or other semiconductor materials. Some example applications of PICs may include optical modulators, optical switches, and/or optical wavelength-division multiplexers. Mach-Zehnder interferometer (MZI)-based structures are widely employed in implementing such applications.

Coupling light in and out of a PIC may be challenging due to the large difference in dimensions between an optical waveguide and an optical fiber. For example, the core diameter of a single-mode fiber (SMF) core may be in the order of micrometers (μm) (e.g., about 5 μm to about 9 μm), whereas the core diameter of an optical waveguide may be less than 1 μm.

### SUMMARY

In one embodiment, the disclosure includes an optical device comprising a first optical interface comprising a first optical waveguide disposed on a surface of a substrate, wherein the first optical waveguide comprises a first wide middle portion that tapers to a first narrow end along a first direction of light propagation and a second narrow end along a second direction of light propagation opposite to the first direction, a first diffraction grating disposed at about the first wide middle portion of the first optical waveguide, and a first optical fiber in optical communication with the first optical waveguide and the first diffraction grating, wherein the first optical fiber is positioned at about perpendicular to the surface and directed towards the first diffraction grating to cause an incoming light signal from the first optical fiber to split into a first portion and a second portion through a diffraction at the first diffraction grating, and wherein the diffraction causes the first portion to propagate towards the first narrow end along the first direction and the second portion to propagate towards the second narrow end along the second direction.

In another embodiment, the disclosure includes a photonic integrated circuit (PIC) comprising a first optical interface comprising a first tapered waveguide disposed on a plane of the PIC, wherein the first tapered waveguide comprises a first wide middle portion that tapers to a first narrow end along a first direction of light propagation and a second narrow end along a second direction of light propagation opposite to the first direction, a first diffraction grating disposed at about the first wide middle portion of the first tapered waveguide, and a first out-of-plane optical fiber in optical communication with the first tapered waveguide and the first diffraction grating, wherein the first out-of-plane optical fiber is positioned at about 90 degrees (°) with respect to the plane and directed towards a surface of the first diffraction grating such that a first light signal propagating along the first direction towards the first diffraction grating and a second light signal propagating along the second direction towards the first diffraction grating are combined and transferred to the first out-of-plane optical fiber.

In yet another embodiment, the disclosure includes a method comprising disposing a tapered optical waveguide on a plane of an integrated circuit, wherein the tapered optical waveguide comprises a wide middle portion that tapers to a first narrow end along a first direction of light propagation and a second narrow end along a second direction of light propagation opposite to the first direction, disposing an SGC at about the wide middle portion of the tapered optical waveguide, and coupling an optical fiber to the SGC such that the optical fiber is oriented at about ninety degrees with respect to the plane to provide optical couplings between a first light signal propagating through the optical fiber, a second light signal propagating through the tapered optical waveguide in the first direction, and a third light signal propagating through the tapered optical waveguide in the second direction.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an MZI device.

FIG. 2 is a schematic diagram of another MZI device.

FIG. 3 is a perspective view of a fiber and a PIC in a coupling position.

FIG. 4 is a top view of a waveguide grating coupler structure comprising a single tapered section.

FIG. 5 is a schematic diagram of an SGC-based optical splitter according to an embodiment of the disclosure.

FIG. 6 is a schematic diagram of an SGC-based MZI according to an embodiment of the disclosure.

FIG. 7 is a schematic diagram of a hybrid SGC-based MZI device according to an embodiment of the disclosure.

FIG. 8 is a top view of a waveguide grating coupler structure comprising two tapered sections according to an embodiment of the disclosure.

FIG. 9 is a cross-sectional view of a waveguide grating coupler structure according to an embodiment of the disclosure.

FIG. 10 is a schematic diagram of an embodiment of a grating diffraction scheme.

FIG. 11 is a flowchart of an embodiment of a method for configuring an SGC-based optical coupler.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalent.

One approach to coupling light in and out of a PIC may be to employ a grating-based vertical coupling method, in which an optical fiber may be vertically coupled to a waveguide grating coupler at a small incidence angle, for example, less than about 20° with respect to an axis perpendicular to the plane of the waveguide grating coupler. The incidence angle is designed to provide coupling through a first-order grating diffraction at the waveguide grating coupler and may depend on the design of the waveguide grating coupler. In such vertical coupling methods, the coupling efficiency may depend on the alignment accuracies (e.g., incidence angle) between the optical fiber and the PIC, and thus may increase manufacturing and/or packaging cost.

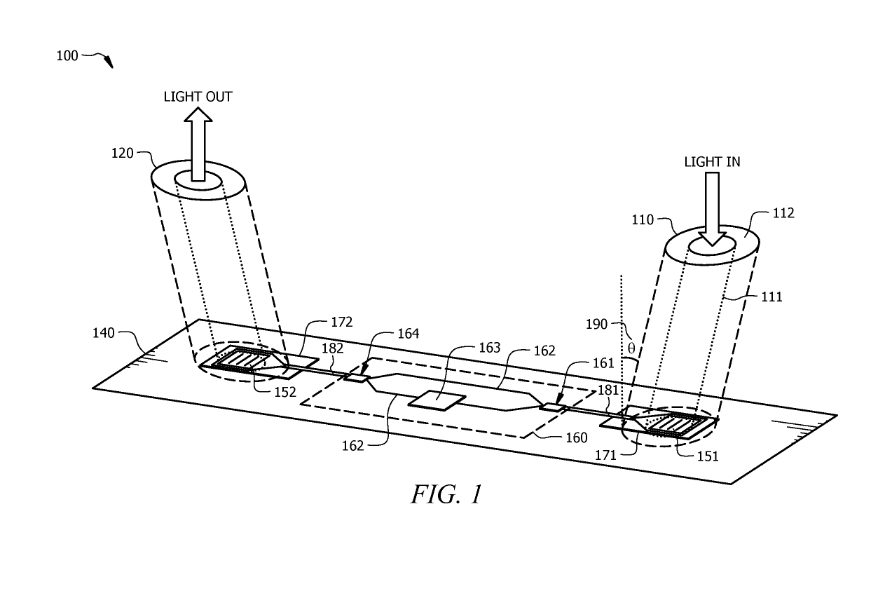

FIG. 1 is a schematic diagram of an MZI device 100. The device 100 may comprise a 1×1 MZI 160, SGCs 151 and 152, tapered waveguides 171 and 172, an input waveguide 181, and an output waveguide 182 disposed on a plane 140 of the device 100. The plane 140 may be a surface of a substrate platform built from silicon, silica, and/or other semiconductor materials. The plane 140 may also be referred to as a chip-plane. Thus, the MZI 160, the SGCs 151 and 152, the tapered waveguides 171 and 172, the input waveguide 181, and the output waveguide 182 may be referred to as on-chip components and/or in-plane components. The MZI 160 may be coupled to an input fiber 110 via the SGC 151, the tapered waveguide 171, and the input waveguide 181. Similarly, the MZI 160 may be coupled to an output fiber 120 via the SGC 152, the tapered waveguides 172, and the output waveguide 182. The input fiber 110 and the output fiber 120 may be nearly vertically coupled to the plane 140, and thus may be referred to as out-of-plane fibers.

The MZI 160 may be a standard 1×1 MZI, which may receive one input and produce one output. The MZI 160 may comprise a pair of interferometer arms 162 coupled to a first optical coupler 161 at an input end and a second optical coupler 164 at an output end. The first optical coupler 161 may be a standard optical coupler, such as an optical splitter, a Y-junction coupler, a multi-mode interference (MMI) coupler, a directional coupler, configured to split a light signal into a first portion and a second portion. For example, the optical coupler 161 may be a power splitter that splits an input signal into two portions, each comprising a substantially similar power. Each portion of the light signal may propagate through one of the interferometer arms 162. The second optical coupler 164 may be substantially similar to the first optical coupler 161. However, the second optical coupler 164 may be configured as a standard optical combiner, which may combine light signals instead of splitting a light signal.

The interferometer arms 162 may be photonic wire waveguides (e.g., silicon nanowire), each configured to direct and guide the first portion or the second portion of the light signal along an optical path. The MZI 160 may further comprise at least one phase shifter 163 coupled to one of the interferometer arms 162 to provide a phase differential between the optical paths of the interferometer arms 162, for example, by changing the refractive index or the length of at least one of the interferometer arms 162. Depending on the phase differential, the output light signals from the interferometer arms 162 may be recombined more efficiently (e.g., constructively), less efficiently, or not at all (e.g., destructively) at the second optical coupler 164. As such, the MZI 160 may provide optical modulation, optical switching, and/or wavelength de-multiplexing functions. The input end of the MZI 160 and/or the first optical coupler 161 may be coupled to the input waveguide 181 and the output end of the MZI 160 and/or the second optical coupler 164 may be coupled to the output waveguide 182.

The input waveguide 181 and the output waveguide 182 may be photonic wire waveguides (e.g., silicon nanowire). The input waveguide 181 may be coupled to the tapered waveguide 171 such that the input waveguide 181 is positioned between the input end of the MZI 160 and the tapered waveguide 171. The input waveguide 181 may be configured to provide an optical path from the tapered waveguide 171 to the input end of the MZI 160. The output waveguide 182 may be coupled to the tapered waveguide 172 such that the output waveguide 182 is positioned between the output end of the MZI 160 and the tapered waveguide 172. The output waveguide 182 may be configured to provide an optical path from the output end of the MZI 160 to the tapered waveguide 172.

The tapered waveguides 171 and 172 may comprise a core layer (not marked) and a cladding layer (not marked). The cladding layer may be formed around the core layer along a direction of light propagation. The core layer may be built from a higher index material than the cladding layer such that a light signal propagating along the core layer may be confined to the core layer. For example, the core layer may be constructed from silicon and the cladding layer may be constructed from silica. In some embodiments, the cladding layer may be constructed from several different layers of materials. The core layer may comprise a tapered structure with a wide end that tapers into a narrow tip. For example, the wide end may comprise a width substantially close to a single-mode fiber (SMF) core diameter (e.g., about 5 μm to 9 μm) and the narrow tip may comprise a substantially smaller width (e.g., less than about 1 μm). As such, the tapered waveguides 171 and 172 may provide adiabatic optical mode conversions between optical components with different dimensions. For example, the tapered waveguide 171 may couple light signals between the input fiber 110 and the input waveguide 181 and the tapered waveguide 172 may couple light signals between the output fiber 120 and the output waveguide 182. In order to couple light signals from the input fiber 110 and/or to the output fiber 120, the tapered waveguides 171 and 172 may be incorporated with an SGC. Specifically, the SGC 151 may be disposed on the wide end of the tapered waveguide 171, and the SGC 152 may be disposed on the wide end of the tapered waveguide 172.

The SGCs 151 and 152 may comprise a periodic structure comprising a finite number of grating teeth (e.g., ridges) separated by spaces and/or slits, where the periodicity of the teeth may be referred to as the grating period. The periodic structure may split and diffract an incident light signal into several light signals travelling in different path directions. The incidence angle of the light signal, the grating period, and/or the wavelength of the light signal may determine the different path directions. By positioning the input fiber 110 and the output fiber 120 appropriately, described more fully below, the SGC 151 may be configured to diffract a light signal from the input fiber 110 into the tapered waveguide 171, while the SGC 152 may be configured to diffract a light signal from the tapered waveguide 172 into the output fiber 120.

The input fiber 110 may comprise a core 111 surrounded by a cladding 112. The core 111 may be built from a material (e.g., glass or plastic) comprising a higher refractive index than the cladding 112 such that the cladding 112 may confine a light signal propagating along the input fiber 110 in the core 111. In some embodiments, the input fiber 110 may be an SMF and the core 111 may comprise a cross-sectional diameter of about 5 μm to about 9 μm. The output fiber 120 may be substantially similar to the input fiber 110.

In order to couple an input light signal from the input fiber 110 to the MZI 160, the input fiber 110 may be coupled to the SGC 151 by positioning the input fiber 110 at an angle 190, represented by θ, to the SGC 151 in an about normal position such that the SGC 151 may diffract the input light signal from the input fiber 110 into the tapered waveguide 171. For example, the angle 190 may be less than about 20° with respect to an axis about perpendicular to the plane 140, and the input fiber 110 may be configured to tilt away from the MZI 160. The angle 190 may be designed to provide a first-order diffraction at the SGC 151. The tapered waveguide 171 may couple the input light signal from the SGC 151 to the input waveguide 181. The input waveguide 181 may couple the input light signal from the tapered waveguide 171 to the first optical coupler 161.

Similarly, the MZI 160 output signal may be coupled out of the plane 140 to the output fiber 120 by employing substantially similar mechanisms as in the input coupling mechanisms described above, but may be in a reverse direction. For example, the output waveguide 182 may couple the output light signal from the second optical coupler 164 to the tapered waveguide 172, the tapered waveguide 172 may couple the output light signal to the SGC 152, and the SGC 152 may couple the output light signal to the output fiber 120 through diffraction, where the output fiber may be positioned in a substantially similar angle, θ, as the input fiber 110.

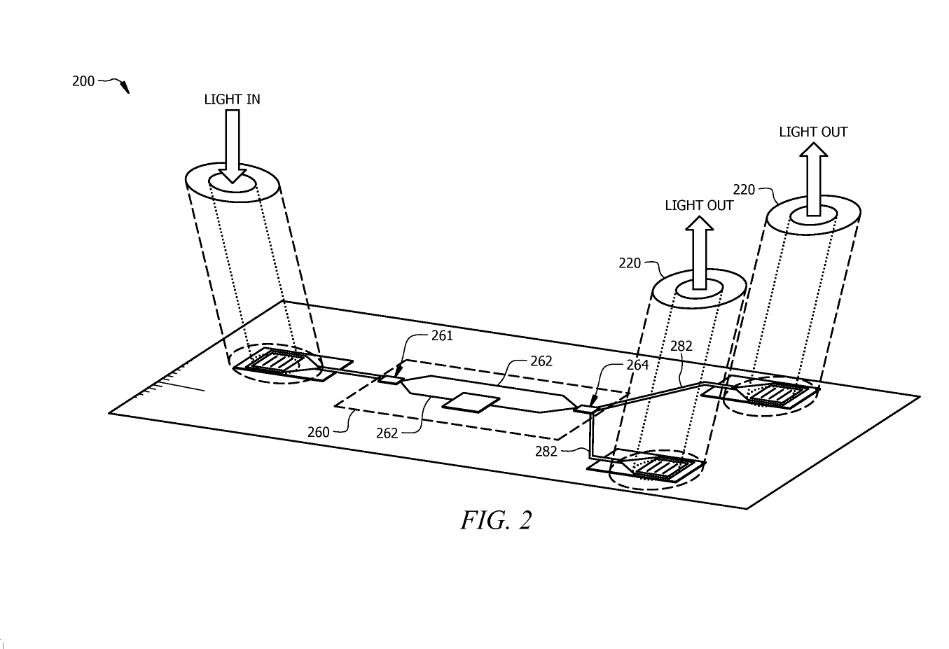

FIG. 2 is a schematic diagram of another MZI device 200. The device 200 may be substantially similar to the device 100, but may comprise a 1×2 MZI 260 instead of a 1×1 MZI. The MZI 260 may comprise a pair of interferometer arms 262 positioned between a first optical coupler 261 and a second optical coupler 264. The interferometer arms 262, the first optical coupler 261, and the second optical coupler 264 may be substantially similar to the interferometer arms 162, the first optical coupler 161, and the second optical coupler 164, respectively. However, the second optical coupler 264 may provide two outputs, for example, switching an input signal received from the first optical coupler 261 between the two outputs depending on the phase differentials between the interferometer arms 262. Each output may be coupled to an output waveguide 282, followed by an output fiber 220, by employing substantially similar output coupling mechanisms as described for the device 100. The output waveguides 282 and the output fibers 220 may be substantially similar to the output waveguide 182 and the output fiber 120, respectively.

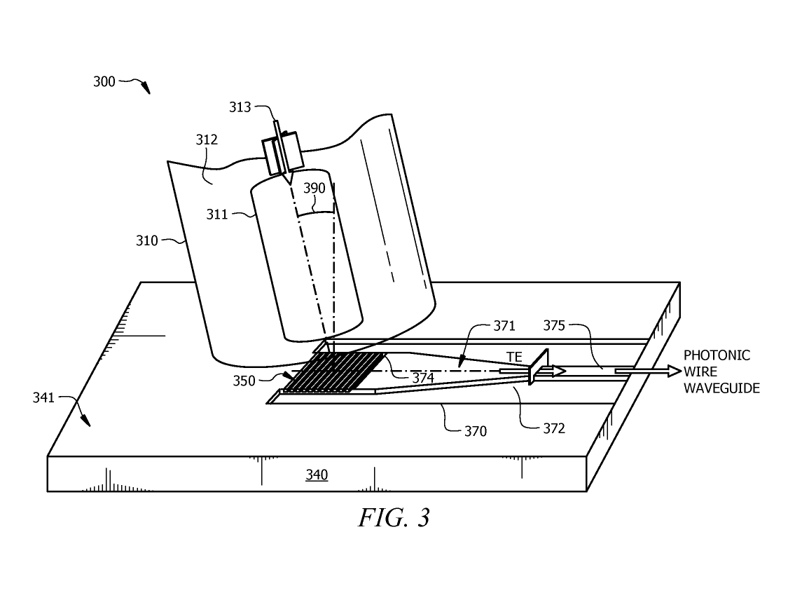

FIG. 3 is a perspective view 300 of a fiber 310 and a PIC 340 in a coupling position. The perspective view 300 illustrates a more detailed view of the input fiber-to-chip coupling mechanisms described above in the device 100 and 200. The PIC 340 may comprise an SGC 350 disposed on a tapered waveguide 370 positioned on a plane 341 of the PIC 340. The SGC 350, the tapered waveguide 370, and the plane 341 may be substantially similar to the SGC 151, the tapered waveguide 171, and the plane 140, respectively. The fiber 310 may be substantially similar to the fiber 110 and may comprise a core 311, similar to the core 111, surrounded by a cladding 312, similar to the cladding 112.

The tapered waveguide 370 may comprise a core layer 371, a lower cladding layer 372, and an upper cladding layer (not shown). The core layer 371 may comprise a tapered structure with a wider end 374 that is linearly tapered into an opposite narrower end 375 to provide optical mode conversions, for example, between a fiber and a silicon nanowire waveguide. The core layer 371 may be built from a high-index material (e.g., silicon) and the cladding layer 372 may be built from a lower-index material (e.g., silica) such that the cladding layer 372 may confine a light signal propagating along the tapered waveguide 370 in the core layer 371.

The SGC 350 may be disposed on a portion of the wider end 374 of the core layer 371. The fiber 310 may be positioned at a pre-determined angle 390, represented by θ, to the surface of the SGC 350 in an about normal position such that the SGC 350 may diffract an incident light signal 313 travelling through the core 311 of the fiber 310 into the core layer 371 of the tapered waveguide 370. The angle 390 may be configured to cause a first-order Bragg grating diffraction at the SGC 350 such that a major portion of the incident light signal 313 may be directed into the tapered waveguide 370 towards the narrower end 375. For example, the angle 390 may be about 10°. The Bragg grating diffraction may refer to optical interference caused by slits in a grating structure. The order of diffraction may be dependent on various factors, such as wavelength of an optical signal, the grating period of a grating structure, and/or the angle of diffraction, discussed more fully below.

The tapered waveguide 370 may direct and transition the wider incident light signal 313 towards a narrow photonic wire waveguide and/or couple to other optical components on the PIC 340 for optical signal processing. It should be noted that the polarization of the SGC 350 may determine the polarization component that may travel along the tapered waveguide 370. For example, when the SGC 350 is a transverse electric (TE)-polarized SGC, the TE polarization component of the incident light signal 313 may propagate along the tapered waveguide 370 (e.g., as shown in FIG. 3). Alternatively, when the SGC 350 is a transverse-magnetic (TM)-polarized SGC, the TM polarization component of the incident light signal 313 may propagate along the tapered waveguide 370.

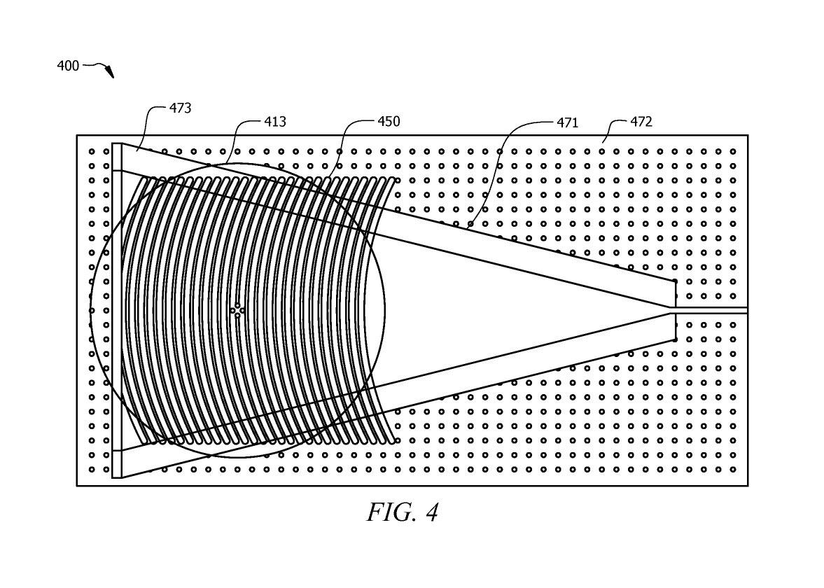

FIG. 4 is a top view of a waveguide grating coupler structure 400 comprising a single tapered section. The structure 400 may be disposed on a surface of a substrate platform or a plane of a PIC, similar to the PIC 340, to facilitate light coupling in and/or out of the PIC. The structure 400 may comprise an SGC 450 disposed on a tapered core layer 471 that is surrounded by a cladding layer 472. The SGC 450, the tapered core layer 471, and the cladding layer 472 may be substantially similar to the SGC 350, the core layer 371, and the cladding layer 372, respectively. However, the SGC 450 may comprise curved gratings instead of linear gratings as in the SGC 350. The curved gratings may comprise teeth separated by gaps and may be structurally similar to the linear gratings, but may be curved in the plane to focus light signals down to the dimensions of the narrow end, for example, for coupling to a photonic wire waveguide. The SGC 450 may be disposed on a portion at about the wide end 473 of the tapered core layer 471 to facilitate coupling of light signals from an out-of-plane fiber, such as the fiber 310. The region 413 may represent the spot size of an incident light signal, for example, from the out-of-plane fiber vertically coupled to the structure 400.

Disclosed herein are techniques for efficiently implementing SGC-based optical couplers for PIC integration. Instead of an SGC performing PIC I/O coupling and being indirectly coupled to a splitter or a combiner, the disclosed embodiments may provide a single optical interface that facilitates fiber-to-chip coupling and optical splitting or a single optical interface that facilitates chip-to-fiber coupling and optical combining without standard optical splitters, combiners, and couplers (e.g., Y-junction couplers, MMI couplers, and/or directional couplers). The optical interface may comprise a single tapered waveguide, an SGC, and an input/output (I/O) fiber. The tapered waveguide may comprise a wide middle portion that tapers into two opposite narrow tips in a direction of light propagation and may be fabricated on a substrate platform (e.g., silicon, silica, and/or semiconductor materials). The SGC may be disposed at about the wide middle portion of the tapered waveguide. The I/O fiber may be positioned at about 90° to a surface of the SGC to cause a second-order Bragg grating diffraction. The second-order Bragg grating diffraction may cause an incident light signal from the I/O fiber to diffract into the tapered waveguide, where the diffracted light signal may split into two portions propagating in opposite directions along the tapered waveguide. Conversely, the second-order Bragg grating diffraction may cause two light signals traveling in opposite directions in the tapered waveguide from the narrow tips to the wide middle portion to diffract into the I/O fiber, and thus provide an optical combining function. To improve coupling efficiency, the SGC coupling region may be coated with an anti-reflective (AR) coating on a surface opposite to the substrate platform and/or disposing a distributed Bragg reflector (DBR) between the tapered waveguide and the substrate platform. In an embodiment, on-chip MZIs, Michaelson interferometers, and/or any suitable types of interferometers may be built from one or more SGC-based optical couplers instead of employing standard optical couplers and additional I/O waveguides for coupling I/O ports to the standard optical couplers. Thus, the disclosed embodiments may provide PICs with more compact footprints and may enable more efficient utilization of the chip area. In addition, by positioning the fiber in an about perpendicular position to the PIC instead of at a particular small angle (e.g., about 5° to about 20°), packaging may be simpler, and thus may lower packaging and/or manufacturing cost.

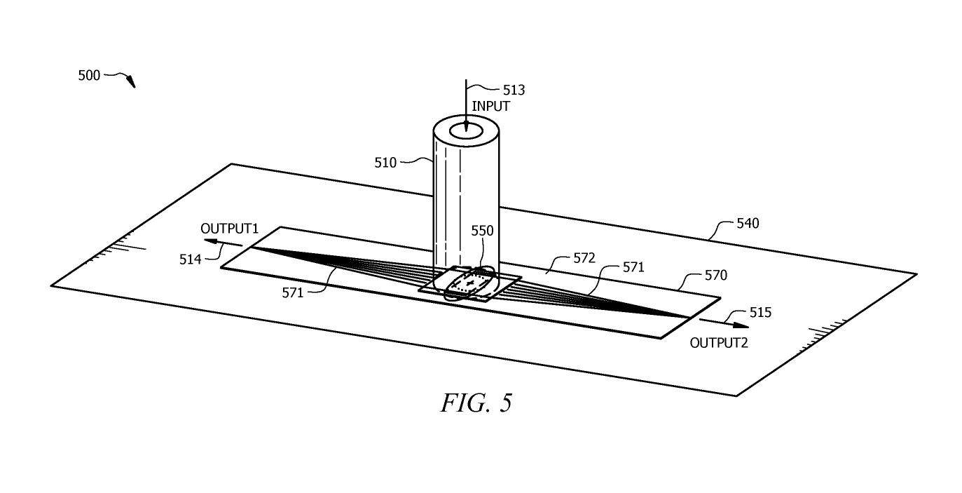

FIG. 5 is a schematic diagram of an SGC-based optical splitter 500 according to an embodiment of the disclosure. The SGC-based optical splitter 500 may be disposed on a chip-plane 540, which may be a plane of a PIC, such as the PIC 340. The SGC-based optical splitter 500 may be integrated with other optical components in the PIC. The SGC-based optical splitter 500 may comprise a fiber 510 perpendicularly coupled to an SGC 550 disposed on a portion of a tapered waveguide 570 to provide a splitting ratio of about 50:50 (e.g., about equal power), where the fiber 510 and the SGC 550 may be substantially similar to the input fiber 110 and the SGC 350. In some embodiments, the angle of the fiber 510 may be adjusted to provide a different splitting ratio.

The tapered waveguide 570 may comprise a core layer 571 and a cladding layer 572 formed along a direction of light propagation, where the core layer 571 may be formed in about the middle of the tapered waveguide 570 and the cladding layer 572 may be formed around the core layer 571. The core layer 571 may be built from a material (e.g., silicon) comprising a higher refractive index than the cladding layer 572 (e.g., silica) such that the cladding layer 572 may confine a light signal propagating along the tapered waveguide 570 in the core layer 571. The core layer 571 may comprise a tapered structure with a wide middle portion (e.g., a width of about 8-10 μm) that is linearly tapered into two opposite narrow ends (e.g., a width of less than about 1 μm) to provide adiabatic optical mode conversions, for example, between a fiber and two silicon nanowire waveguides, one at each narrow end.

The SGC 550 may be positioned at about the wide middle portion of the core layer 571. The fiber 510 may be positioned about perpendicular to a surface (e.g., light incident surface) of the SGC 550 such that an input light signal 513 from the fiber 510 may be vertically incident (e.g., incidence angle of about 90°) to the surface of the SGC 550. The about 90° incidence angle may cause a second-order Bragg grating diffraction at the SGC 550. The second-order Bragg grating diffraction may cause the input light signal 513 entering the SGC 350 to propagate into opposite directions along the tapered waveguide 570 towards the narrow ends of the tapered waveguide 570 to provide a first output signal 514 and a second output signal 515. As such, the SGC-based optical splitter 500 may provide both fiber-to-chip coupling and power splitting functionalities. Similarly, the SGC-based optical splitter 500 may provide both chip-to-fiber coupling and power combining functionalities when operating in a reverse direction. It should be noted that the splitting ratio between the first output signal 514 and the second output signal 515 may be dependent on the incidence angle of the input light signal 513. For example, when the incidence angle is at about 90°, the splitting ratio may be about 50/50.

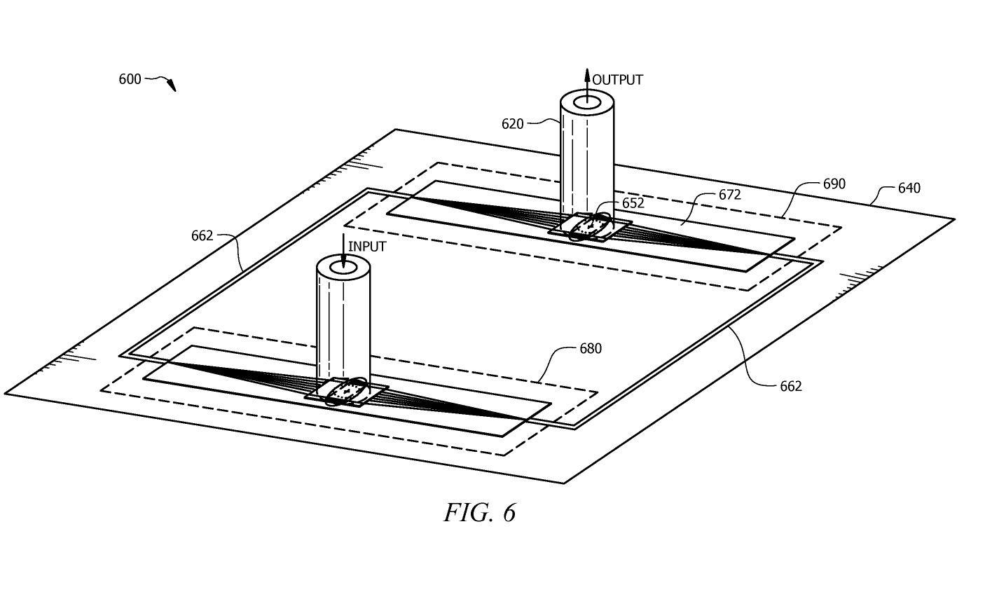

FIG. 6 is a schematic diagram of an SGC-based MZI 600 according to an embodiment of the disclosure. The SGC-based MZI 600 may be disposed on a chip-plane 640, similar to chip-plane 540. The SGC-based MZI 600 may be integrated with other optical components. The SGC-based MZI 600 may comprise a pair of interferometer arms 662 positioned between an SGC-based optical splitting section 680 and an SGC-based optical combining section 690. The interferometer arms 662 may be substantially similar to the interferometer arms 162 and at least one of the interferometer arms 662 may comprise a phase shifter (not shown), such as the phase shifter 163. Both the SGC-based optical splitting section 680 and the SGC-based optical combining section 690 may comprise substantially similar structures as in the SGC-based optical splitter 500, but the SGC-based optical combining section 690 may couple a light signal in a reverse direction. For example, the SGC-based optical combining section 690 may comprise an output fiber 620, similar to the fiber 510, vertically coupled to an SGC 652, similar to the SGC 550, at an angle of about 90° with respect to a surface of the SGC 652. The SGC 652 may be disposed on a tapered waveguide 672, similar to the tapered waveguide 570.

In the SGC-based optical combining section 690, the SGC 652 may combine the light signals propagating through each of the interferometer arms 662 and transfer the combined signal into the output fiber 620 through a second-order Bragg grating diffraction in a reverse direction, for example, to cause convergence of light signals. As such, the SGC-based MZI 600 may be realized on a PIC without standard optical couplers and/or additional waveguides to couple light signals into and/or out of the optical couplers. Thus, the SGC-based MZI 600 may provide a PIC with a more compact footprint and may simplify packaging, and thus may reduce packaging cost. The combining ratio in the SGC-based optical combining section 690 may be dependent on the angle of the output fiber 620. For example, when the output fiber 620 is coupled at about 90° to the SGC 652, the combining ratio may be about 50/50.

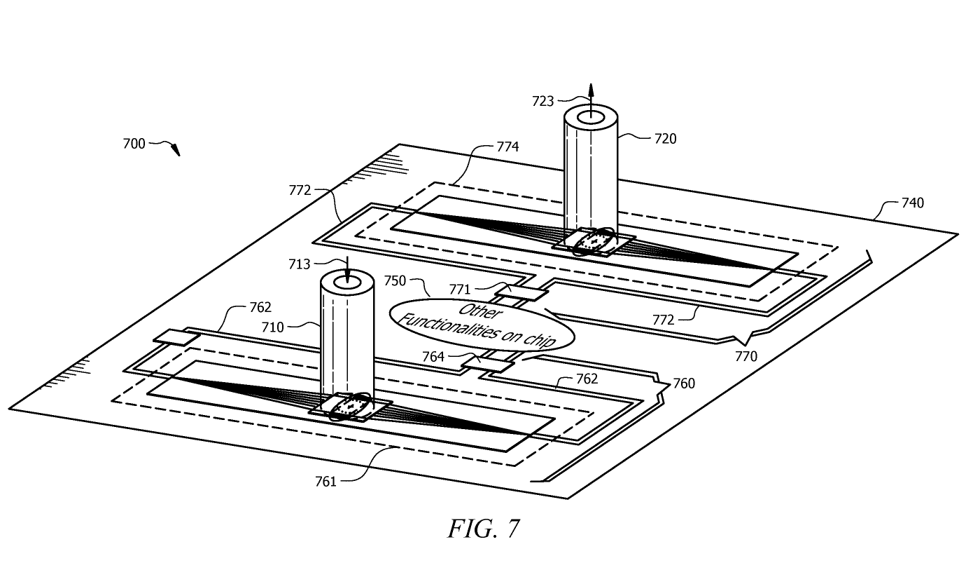

FIG. 7 is a schematic diagram of a hybrid SGC-based MZI device 700 according to an embodiment of the disclosure. The hybrid SGC-based MZI 700 may be disposed on a chip-plane 740, similar to the chip-plane 640. The hybrid SGC-based first MZI 700 may comprise a first MZI 760, an optical circuit 750, and a second MZI 770. The optical circuit 750 may be positioned between the first MZI 760 and the second MZI 770.

The first MZI 760 may comprise a pair of interferometer arms 762, similar to the interferometer arms 662, positioned between an SGC-based optical splitting section 761, similar to the SGC-based optical splitting section 680, and a standard optical coupler 764, similar to the second optical coupler 164. The SGC-based optical splitting section 761 may comprise an input fiber 710, similar to the fiber 510, and may couple an input light signal 713 into the device 700 by employing substantially similar input coupling mechanisms as in the SGC-based splitter 500.

The second MZI 770 may comprise a pair of interferometer arms 772, similar to the interferometer arms 662, positioned between a standard optical coupler 771, similar to the first optical coupler 161, and an SGC-based optical combining section 774, similar to the SGC-based optical combining section 690. The SGC-based optical combining section 774 may comprise an output fiber 720, similar to the fiber 620, and may couple a light signal 723 from the device 700 to the output fiber 720 by employing substantially similar output coupling mechanisms as in the SGC-based optical combining section 690.

The optical circuit 750 may comprise a plurality of interconnecting optical components, such as optical splitters, optical combiners, waveguides, wavelength filters, wavelength-division multiplexers and demultiplexers, etc., to perform various optical signal processing functions. As such, the input light signal 713 may be processed by the first MZI 760, followed by the optical circuit 750, and then the second MZI 770 to produce the output light signal 723.

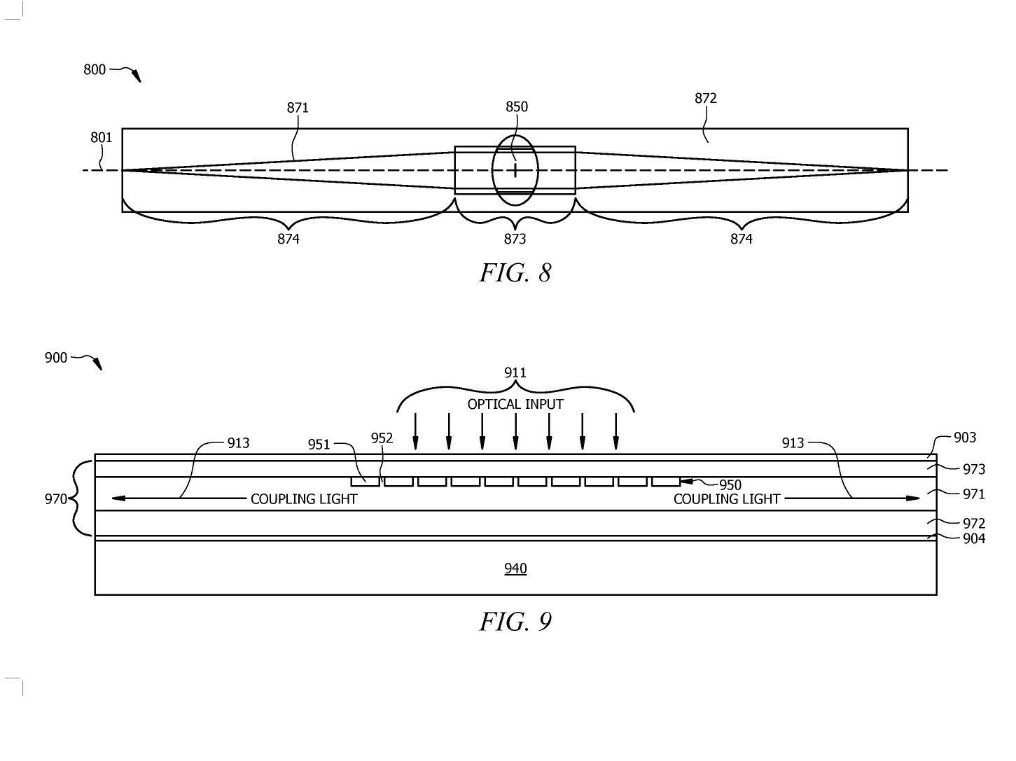

FIG. 8 illustrates a top view of a waveguide grating coupler structure 800 comprising two tapered sections 874 according to an embodiment of the disclosure. The structure 800 may be disposed on a chip-plane, similar to the chip-plane 540 and/or a surface of a substrate platform. The structure 800 may comprise an SGC 850 disposed on a tapered core layer 871 and a cladding layer 872 formed around the tapered core layer 871, where the tapered core layer 871 comprises a wide middle section 873 that transitions to the two tapered sections 874. The SGC 850, the tapered core layer 871, and the cladding layer 872 may be substantially similar to the SGC 550, the core layer 571, and the cladding layer 572, respectively. It should be noted that the top view is shown with the cladding layer 872 removed from the top of the structure 800.

FIG. 9 is a cross-sectional view of a waveguide grating coupler structure 900 according to an embodiment of the disclosure. The cross-sectional view may correspond to a cross-sectional area along a line 801 in the structure 800. The structure 900 may comprise a tapered waveguide 970, similar to the tapered waveguide 570, disposed on a substrate layer 940. The tapered waveguide 970 may comprise a core layer 971 formed between a first cladding layer 973 and a second cladding layer 972. The core layer 971 may be substantially similar to the tapered core layer 871. The first cladding layer 973 and the second cladding layer 972 may be substantially similar to the cladding layer 872. The second cladding layer 972 may be disposed on the substrate layer 940. The structure 900 may further comprise an SGC 950, similar to the SGC 850, disposed on a surface of the core layer 971 opposite to the substrate layer 940 and at about the middle portion of the core layer 971.

The SGC 950 may comprise a periodic structure with a plurality of teeth 951 separated by gaps 952 such that the SGC 950 may cause an incident light signal 911 to split into two about equal portions 913 propagating in opposite directions along the core layer 971 of the tapered waveguide 970 through a second-order Bragg grating diffraction.

The structure 900 may further comprise an anti-reflective coating 903 disposed on a surface of the first cladding layer 973 opposite to the substrate layer 940 and a DBR 904 disposed between the second cladding layer 972 and the substrate layer 940. The structure 900 may be built from various optical materials, such as silica-on-silicon, indium phosphide (InP), silicon oxynitride (SiON), silicon nitride (Si₃N₄), etc.

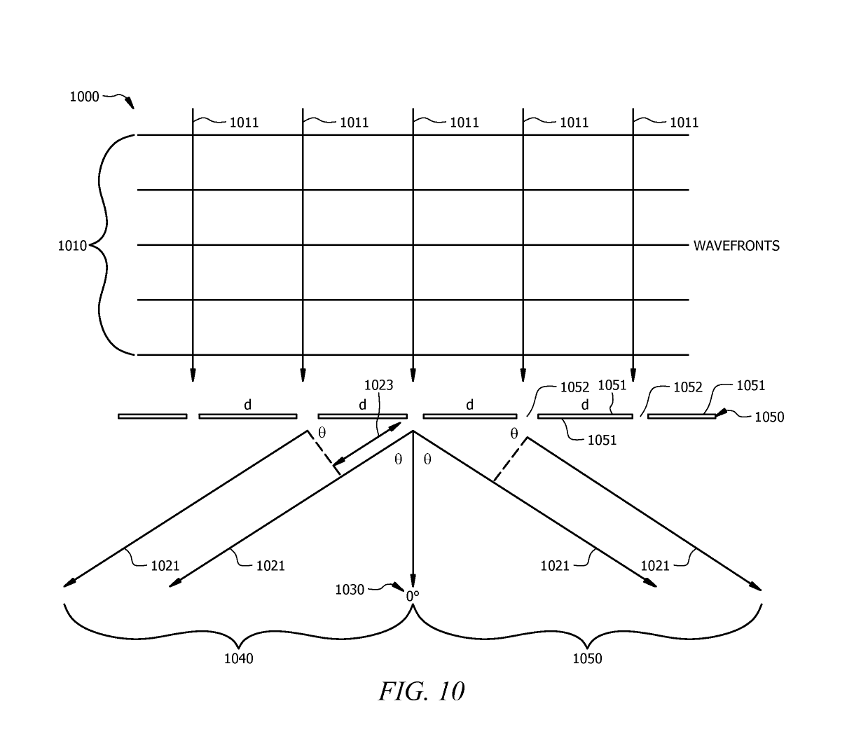

FIG. 10 is a schematic diagram of an embodiment of a grating diffraction scheme 1000. The scheme 1000 may be similar to the grating diffraction scheme as described at http://www.physics.smu.edu/˜scalise/emmanual/diffraction/lab.html, which is incorporated by reference. The grating diffraction scheme 1000 may be employed in an SGC-based optical splitter, such as the splitter 500, an SGC-based MZI, such as the MZI 600, and/or a hybrid SGC-based MZI, such as the MZI 700. In the scheme 1000, a light signal 1010 comprising a plurality of parallel light rays 1011 may incident on a surface of an SGC 1050, similar to the SGC 950, at incidence angles of about 90° with respect to the surface. The wavefronts of the light rays 1011 may be perpendicular to the light rays 1011 and about parallel to the surface of the SGC 1050. The SGC 1050 may comprise a plurality of periodic teeth 1051, similar to the teeth 951, separated by gaps 1052, similar to the gaps 952. When the light rays 1011 travel through the SGC 1050, the light rays 1011 may diffract at the gaps 1052 causing the light rays 1011 to propagate in different directions to produce diffracted light rays 1021. The directions of the diffracted light rays 1021 may depend on the gaps 1052 and the wavelength of the light signal 1010. The path difference between two diffracted light rays 1021 may be expressed as shown below:

d sin θ=nλ, (1)

where d may represent the distance between the gaps 1052, θ may represent the diffraction angle, n may represent the diffraction order, λ may represent the wavelength of the light signal 1010, and nλ may represent the path difference. An example of path difference is marked as 1023 in FIG. 10.

When the light rays 1011 are incident to the surface of the SGC 1050 at about 90°, the diffraction angles θ on the left of 0° (shown as 1030) and on the right of the 0° may be about equal and in opposite directions. As such, the diffracted light rays 1021 may comprise two portions 1040 and 1050 propagating in about opposite directions.

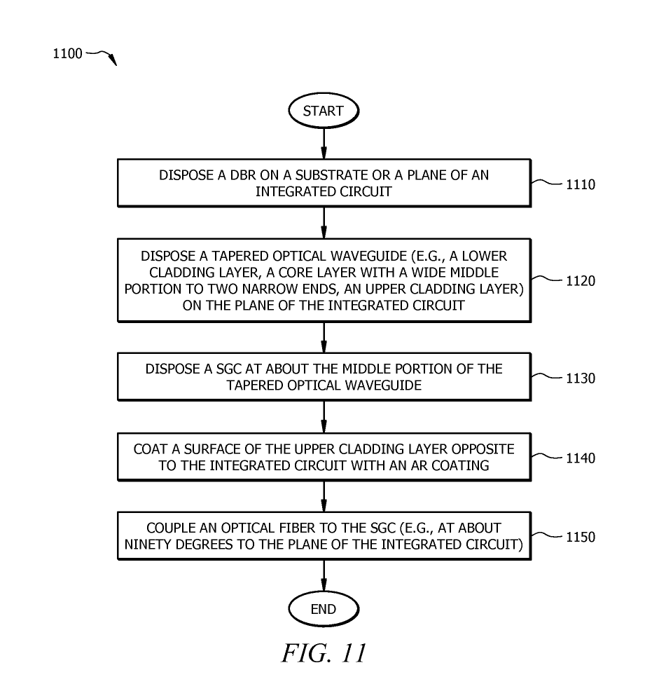

FIG. 11 is a flowchart of an embodiment of a method 1100 for configuring an SGC-based optical coupler, such as the SGC-based optical splitter 500, an SGC-based MZI, such as MZI 600, and/or a hybrid SGC-based MZI, such as MZI 700. The method 1100 may be implemented when designing, manufacturing, and/or packaging PICs that employ optical couplers and/or MZI structures. At step 1100, method 1100 may dispose a DBR on a substrate for producing an integrated circuit. For example, the DBR may be disposed on a plane (e.g., plane 140, 341, 540, 640, and/or 740) of the integrated circuit.

At step 1120, method 1000 may dispose a tapered optical waveguide (e.g., tapered waveguide 570), on the plane of the integrated circuit. For example, method 1100 may dispose a lower cladding layer of the tapered optical waveguide on the substrate, a core layer of the tapered optical waveguide on the lower cladding layer, and then followed by an upper cladding layer of the tapered optical waveguide on the core layer. The core layer may comprise a wide middle portion that tapers into two opposite narrow ends along a direction of light propagation.

At step 1130, method 1100 may dispose an SGC (e.g., SGC 151, 152, 350, 450, 550, 652, 850, and/or 950) at about the middle portion of the tapered optical waveguide (e.g., on the core layer).

At step 1140, method 1100 may coat a surface of the upper cladding layer opposite to the plane of the integrated circuit with an AR coating.

At step 1150, method 1100 may couple an optical fiber (e.g., fiber 110, 120, 220, 310, 510, 620, 710, and/or 720) to the SGC such that the optical fiber is oriented at about 90° with respect to the plane of the integrated circuit to cause a second-order Bragg grating diffraction. As described in the scheme 1000, the second-order Bragg grating diffraction may provide optical couplings between a first light signal propagating through the optical fiber, a second light signal propagating through the tapered waveguide in a first direction, and a third light signal propagating through the tapered optical waveguide in a second direction opposite to the first direction.

When the first light signal is an incident light signal traveling through the fiber towards the SGC, the SGC may diffract the first light signal into the tapered optical waveguide such that the first light signal is split into two about equal portions (e.g., travelling towards the two opposite narrow ends), which may correspond to the second light signal and the third light signal. Alternatively, when the second light signal and the third light signal are traveling from the narrow ends of the tapered optical waveguide towards the middle portion, the SGC may diffract the second light signal and the third light signal into the optical fiber to produce a combined light signal (e.g., corresponding to the first light signal) and output the combined light signal through the optical fiber.

It should be noted that the AR coating may improve optical coupling efficiency, for example, by reducing reflection of the first light signal when the first light signal is an incident light signal from an external source. The DBR may further improve efficiency, for example, by reflecting any light signal that is scattered outside of the tapered optical waveguide towards the tapered optical waveguide. It should be noted that method 1100 may be suitable for implementing MZI-based optical signal processing functions, such as optical switching, optical modulation, optical de-multiplexing, etc. For example, method 1100 may further couple interferometer waveguide arms to the narrow ends of the tapered optical waveguide, where the interferometer waveguide arms may be coupled to other optical circuits. In addition, the sequence of operations depicted in FIG. 11 is for illustrative purposes and may be performed in any suitable order.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Unless otherwise stated, the term “about” means±10% of the subsequent number. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. An optical device comprising:
a first optical interface comprising:
a first optical waveguide disposed on a surface of a substrate, wherein the first optical waveguide comprises a first wide middle portion that tapers to a first narrow end along a first direction of light propagation and a second narrow end along a second direction of light propagation opposite to the first direction;
a first diffraction grating disposed at about the first wide middle portion of the first optical waveguide; and
a first optical fiber in optical communication with the first optical waveguide and the first diffraction grating,
wherein the first optical fiber is positioned perpendicular to the surface and directed towards the first diffraction grating to cause an incoming light signal from the first optical fiber to split into a first portion and a second portion through a diffraction at the first diffraction grating, and
wherein the diffraction causes the first portion to propagate towards the first narrow end along the first direction and the second portion to propagate towards the second narrow end along the second direction.

2. The optical device of claim 1, wherein the first portion and the second portion comprise about equal power.

3. The optical device of claim 1, further comprising a first interferometer waveguide and a second interferometer waveguide disposed on the surface of the substrate, wherein the first interferometer waveguide is coupled to the first narrow end and configured to provide a first optical path for the first portion, and wherein the second interferometer waveguide is coupled to the second narrow end and configured to provide a second optical path for the second portion.

4. The optical device of claim 3, further comprising an optical combiner disposed on the surface of the substrate and coupled to the first interferometer waveguide and the second interferometer waveguide such that the first interferometer waveguide and the second interferometer waveguide are positioned between the optical combiner and the first optical waveguide, wherein the optical combiner is configured to combine the first portion and the second portion.

5. The optical device of claim 3, further comprising a second optical interface comprising:
a second optical waveguide disposed on the surface of the substrate, wherein the second optical waveguide comprises a second wide middle portion that tapers into a third narrow end along a third direction of light propagation and a fourth narrow end opposite to the third narrow end along a fourth direction of light propagation, and wherein the second optical waveguide is coupled to the first interferometer waveguide and the second interferometer waveguide such that the first interferometer waveguide is positioned between the first narrow end of the first optical waveguide and the third narrow end of the second optical waveguide and the second interferometer waveguide is positioned between the second narrow end of the first optical waveguide and the fourth narrow end of the second optical waveguide;
a second diffraction grating disposed at about the second wide middle portion of the second optical waveguide; and
a second optical fiber in optical communication with the second optical waveguide and the second diffraction grating, wherein the second optical fiber is positioned at about perpendicular to the surface and directed towards the second diffraction grating such that the first portion and the second portion are diffracted into the second optical fiber to produce a combined output signal through the second optical fiber.

6. The optical device of claim 3, wherein the optical device is a Mach-Zehnder interferometer (MZI)-based device.

7. The optical device of claim 1, wherein the first optical waveguide comprises a core layer and a cladding layer formed around the core layer along the first direction and the second direction, and wherein a surface of the cladding layer opposite to the substrate is coated with an anti-reflective (AR) coating.

8. The optical device of claim 1, further comprising a distributed Bragg reflector (DBR) disposed between the first optical waveguide and the substrate.

9. The optical device of claim 1, wherein the first diffraction grating is a transverse electric (TE)-polarized grating, and wherein the first portion and the second portion each comprises a TE polarization component.

10. The optical device of claim 1, wherein the first diffraction grating is a transverse magnetic (TM)-polarized grating, and wherein the first portion and the second portion each comprises a TM polarization component.

11. The optical device of claim 1, wherein the first optical interface does not comprise a standard optical splitter.

12. A photonic integrated circuit (PIC) comprising:
a first optical interface comprising:
a first tapered waveguide disposed on a plane of the PIC, wherein the first tapered waveguide comprises a first wide middle portion that tapers to a first narrow end along a first direction of light propagation and a second narrow end along a second direction of light propagation opposite to the first direction;
a first diffraction grating disposed at about the first wide middle portion of the first tapered waveguide; and
a first out-of-plane optical fiber in optical communication with the first tapered waveguide and the first diffraction grating,
wherein the first out-of-plane optical fiber is positioned 90 degrees with respect to the plane and directed towards a surface of the first diffraction grating such that a first light signal propagating along the first direction towards the first diffraction grating and a second light signal propagating along the second direction towards the first diffraction grating are combined and transferred to the first out-of-plane optical fiber.

13. The PIC of claim 12, further comprising a first interferometer waveguide and a second interferometer waveguide disposed on the plane of the PIC, wherein the first interferometer waveguide is coupled to the first narrow end and configured to provide a first optical path for the first light signal, and wherein the second interferometer waveguide is coupled to the second narrow end and configured to provide a second optical path for the second light signal.

14. The PIC of claim 13, further comprising an optical splitter disposed on the plane of the PIC and coupled to the first interferometer waveguide and the second interferometer waveguide such that the first interferometer waveguide and the second interferometer waveguide are positioned between the optical splitter and the first tapered waveguide, wherein the optical splitter is configured to:
receive a third light signal; and
split the third light signal into the first light signal and the second light signal.

15. The PIC of claim 13, further comprising a second optical interface comprising:
a second tapered waveguide comprising a second wide middle portion that tapers to a third narrow end along a third direction of light propagation and a fourth narrow end opposite to the third narrow end along a fourth direction of light propagation in the second tapered waveguide, wherein, the second tapered waveguide is disposed on the plane of the PIC and coupled to the first interferometer waveguide and the second interferometer waveguide such that the first interferometer waveguide is positioned between the first narrow end of the first tapered waveguide and the third narrow end of the second tapered waveguide and the second interferometer waveguide is positioned between the third narrow end of the first tapered waveguide and the fourth narrow end of the second tapered waveguide;
a second diffraction grating disposed at about the second wide middle portion of the second tapered waveguide; and
a second out-of-plane optical fiber in optical communication with the second tapered waveguide and the second diffraction grating, wherein the second out-of-plane optical fiber is positioned at about ninety degrees with respect to the plane and directed towards a surface of the second diffraction grating such that an incident light signal from the second out-of-plane optical fiber is diffracted into the second tapered waveguide causing the incident light signal to split into two about equal portions that propagate in opposite directions along the second tapered waveguide towards the first interferometer waveguide and the second interferometer waveguide, and wherein the two about equal portions correspond to the first light signal and the second light signal.

16. A method comprising:
disposing a tapered optical waveguide on a plane of an integrated circuit, wherein the tapered optical waveguide comprises a wide middle portion that tapers to a first narrow end along a first direction of light propagation and a second narrow end along a second direction of light propagation opposite to the first direction;
disposing a surface grating coupler (SGC) at about the wide middle portion of the tapered optical waveguide; and
coupling an optical fiber to the SGC such that the optical fiber is oriented 90 degrees with respect to the plane to provide optical couplings between a first light signal propagating through the optical fiber, a second light signal propagating through the tapered optical waveguide in the first direction, and a third light signal propagating through the tapered optical waveguide in the second direction.

17. The method of claim 16, wherein the tapered optical waveguide comprises a core layer and a cladding layer along the first direction and the second direction, and wherein the method further comprises coating a surface of the cladding layer opposite to a substrate with an anti-reflective (AR) coating.

18. The method of claim 16, further comprising disposing a distributed Bragg reflector (DBR) between the tapered optical waveguide and the plane of the integrated circuit.

19. The method of claim 16, wherein the SGC causes the first light signal to split into the second light signal and the third light signal.

20. The method of claim 16, wherein the SGC causes the second light signal and the third light signal to combine into the first light signal.

21. The optical device of claim 1, wherein the first diffraction grating and the first optical fiber are configured to cause a second-order diffraction.

22. The PIC of claim 12, wherein the first diffraction grating and the first out-of-plane optical fiber are configured to cause a second-order diffraction.

23. The method of claim 16, wherein the coupling further provides second-order diffraction.

24. An optical device comprising:
a substrate comprising a surface;
an optical waveguide disposed on the surface and comprising a wide middle portion that tapers to a first narrow end and a second narrow end;
a diffraction grating disposed at about the wide middle portion; and
an optical fiber in optical communication with the optical waveguide and the diffraction grating, positioned at an angle that is about perpendicular to the surface, and directed towards the diffraction grating,
wherein the diffraction grating is configured to:
receive a first input light from the optical fiber;
split, through a second-order diffraction, the first input light into a first output light with a first power and a second output light with a second power, wherein a splitting ratio of the first power to the second power is based on the angle;
diffract, through the second-order diffraction, the first output light to the first narrow end and the second output light to the second narrow end;
receive a second input light from the first narrow end and a third input light from the second narrow end;
combine, through the second-order diffraction and with a combining ratio, the second input light and the third input light to create a third output light, wherein the combining ratio is based on the angle; and
diffract, through the second-order diffraction, the third output light to the optical fiber.

25. The optical device of claim 24, wherein the splitting ratio and the combining ratio are the same.
